(19) United States
(12) Patent Application Publication
(10) Pub. No.: US 2008/0181242 A1
(43) Pub. Date: Jul. 31, 2008

(54) COMMUNICATIONS GATEWAY BETWEEN TWO ENTITIES

(75) Inventor: Fabrice MECHADIER, Gif Sur Yvette (FR)

Correspondence Address: OBLON, SPIVAK, MCCLELLAND MAIER & NEUSTADT, P.C., 1940 DUKE STREET, ALEXANDRIA, VA, 22314, US

(73) Assignee: HISPANO SUIZA, Colombes (FR)

(21) Appl. No.: 12/020,847

(22) Filed: Jan. 28, 2008

(30) Foreign Application Priority Data
Jan. 29, 2007 (FR) 0752939

(51) Int. Cl. H04L 12/66

(52) U.S. Cl. 370/401

(57) ABSTRACT

A communications gateway comprising:

a first entity including at least one packet-switching interconnection element communicating by data packets;

a second entity including a set of ports communicating by means of an elementary data set; and

conversion means connecting said first entity with said second entity to convert between said data packets and said elementary data sets in order to enable communication between said first and second entities.

### TECHNICAL FIELD OF THE INVENTION

The invention relates to the field of communication between two entities, and more particularly between a simple entity and another entity that is more complex in a computer architecture for aircraft.

### BACKGROUND OF THE INVENTION

At present, connection devices are known for communicating between two types of entity that do not necessarily share the same topology. In the field of computer system architectures, there exist devices that enable conversion between one type of bus and another type of bus, e.g. to exchange information between one type of high bitrate bus and another type of high bitrate bus.

Furthermore, in order to go from a packet-switching interconnection system of the Serial RapidIO™ type to one or more buses of the serial peripheral interface (SPI) type, i.e. having a synchronized serial port, it is at present necessary to make use of a general purpose microprocessor as a gateway between those two types of bus. That type of gateway or architecture is very expensive, bulky, and very greedy in energy consumption and in computation time.

### OBJECT AND SUMMARY OF THE INVENTION

An object of the invention is to remedy those drawbacks and to optimize cost, compactness, energy consumption, and the speed at which information is exchanged.

These objects are achieved by a communications gateway comprising:

a first entity including at least one packet-switching interconnection element communicating by data packets;

a second entity including a set of ports communicating by means of an elementary data set comprising data that is discrete, in serial form, or in parallel form; and

conversion means connecting said first entity with said second entity to convert between said data packets and said elementary data set so as to enable communication between said first and second entities, said conversion means comprising:

storage means for temporarily storing said data packets coming from said first entity; and

control means for decoding said temporarily-stored data packets to recover elementary data portions dedicated to ports from amongst said set of ports before sending each of said elementary data portions to its destination port.

Thus, the system enables information to be exchanged in a manner that is simple, fast, and inexpensive between a simple entity and another entity that is more complex and that may include a protocol. The system also makes it possible to transmit data in optimum manner from a complex entity capable of including a protocol to a simpler entity. The gateway then makes it possible, for example, to exchange formatted information between a high bitrate bus and one or more low bitrate buses while ensuring independence between the speeds of the various buses. It also makes it possible to monitor the presence or the status of subscribers to the low bitrate bus and to monitor input/output signals.

According to a feature of the present invention, said storage means are designed to store temporarily said elementary data set coming from said second entity, and said control means are designed to transform said temporarily-stored elementary data set into data packets feeding said first entity.

Thus, data can be transmitted to a complex entity from a simple entity that can output simple data only.

Advantageously, said control means are designed to handle information decoded by the first entity from a specific data packet in order to generate a synchronization pulse.

Thus, a hardware-decoded synchronization pulse can easily be integrated in the conversion means, e.g. by decoding a priority frame of the multicast type.

In a first embodiment, the gateway is made in a programmable component. This first embodiment is very flexible and is easily adapted to various types of entity for fast information exchange between the entities. The programming or encoding of the conversion means can readily be modified to adapt to the various components of the system.

In a second embodiment, the gateway is implemented as an application-specific integrated circuit. This makes it possible to use a very high speed integrated circuit in optimum and compact manner for fast information interchange between the entities.

According to a feature of the present invention, said set of ports may comprise discrete inputs/outputs such that said elementary data set comprises discrete data.

According to another feature of the present invention, said set of ports may include at least one serial port such that said elementary data set includes data in serial form. Said at least one serial port may be of the SPI synchronized serial port type. This makes it possible to provide an effective interface with external components in master/slave mode.

According to yet another feature of the present invention, said packet-switching interconnection element is of the Serial RapidIO™ type. The gateway can thus provide a fast interface between the Serial RapidIO™ element and SPI type ports.

The invention also provides an aircraft computer comprising at least one central unit and acquisition means and including at least one gateway according to any of the above characteristics, said gateway being an interface between said at least one central unit and said acquisition means.

### BRIEF DESCRIPTION OF THE DRAWINGS

Other features and advantages of the invention appear on reading the following description made by way of non-limiting indication and with reference to the accompanying drawings, in which:

FIG. 1 is a diagrammatic view of a communications gateway of the invention between two entities;

FIGS. 2 and 3 are diagrammatic views of the FIG. 1 gateway comprising storage means and control means;

FIGS. 4 and 5 are diagrammatic views of two embodiments of FIG. 1;

FIG. 6 is a diagrammatic view of a particular embodiment of FIG. 1; and

FIG. 7 is a diagrammatic view of an aircraft computer using the FIG. 1 gateway.

### DETAILED DESCRIPTION OF EMBODIMENTS

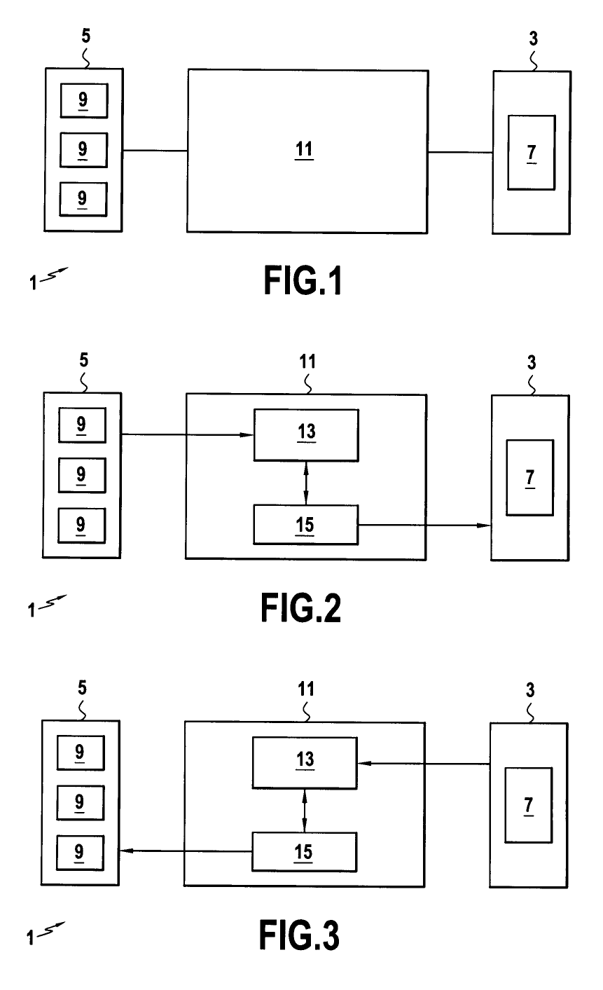

FIG. 1 is a diagram of a communications gateway 1 of the invention between two entities 3 and 5.

The first entity 3 includes at least one packet-switching interconnection element 7 communicating by means of data packets. By way of example, the packet-switching interconnection element is of the Serial RapidIO™ type that provides the logical, transport, and physical layers of the RapidIO™ standard.

The second entity 5 includes a set of ports 9 that could naturally comprise a single port only, communicating by means of a set of base or elementary data. The term “elementary data” is used to designate simple or standard data that may be discrete or in serial form.

The set of ports 9 may comprise discrete inputs/outputs communicating by means of discrete data, or serial ports communicating by means of serial data, or possibly parallel ports. Thus, the elementary data set may comprise data that is discrete, in serial form, or possibly in parallel form.

By way of example, the set of ports 9 may comprise one or more general purpose IO (GPIO) ports and one or more synchronized serial peripheral interface (SPI) ports.

The gateway also comprises conversion means 11 connecting the first entity 3 the second entity 5 to convert between data packets and the elementary data set so as to enable communication to take place between the first and second entities 3 and 5.

FIGS. 2 and 3 show that the communications gateway 1 may comprise storage means 13 and control means 15.

FIG. 2 shows data being transmitted from the second entity 5 to the first entity 3.

The storage means 13 enable the elementary data set coming from the second entity 5 to be stored temporarily. Furthermore, the control means 15 recover the temporarily-stored elementary data in order to transform it into data packets for the purpose of feeding the first entity 3.

FIG. 3 shows data being transmitted from the first entity 3 towards the second entity 5.

The storage means 13 serve to store temporarily data packets coming from the first entity 3. The control means 15 also serve to decode the temporarily-stored data packets in order to recover the elementary data portions that are dedicated to particular ports of the set of ports 9, prior to sending each of these elementary data portions to the appropriate destination port 9.

Thus, by way of example, it is possible to exchange formatted data between a high bitrate bus and one or more low bitrate buses while providing independence between the speeds of the various buses. In addition to exchanging information or data, there are data transmission signals and control signals (e.g. clock signals). Thus, it is possible to verify the presence or the state of subscribers to the low bitrate bus and also input/output signals. For example, data exchange between subscribers can take place cyclically such that if the gateway does not receive a response, it concludes that the subscriber is absent.

Advantageously, the control means 15 can also handle information decoded by the first entity 3 from a specific data packet in order to generate a synchronization pulse. For example, the conversion means 11 may be informed about the arrival of an ultra-high priority short frame of the “multicast event” type for transmitting clock signals or a synchronization pulse via an output of said conversion means 11. It should be observed that decoding the ultra-high priority short frame is performed by the packet-switching interconnection element 7 of the entity 3. This makes it possible to activate a discrete signal and to inform the conversion means 11 so as to generate the synchronization pulse.

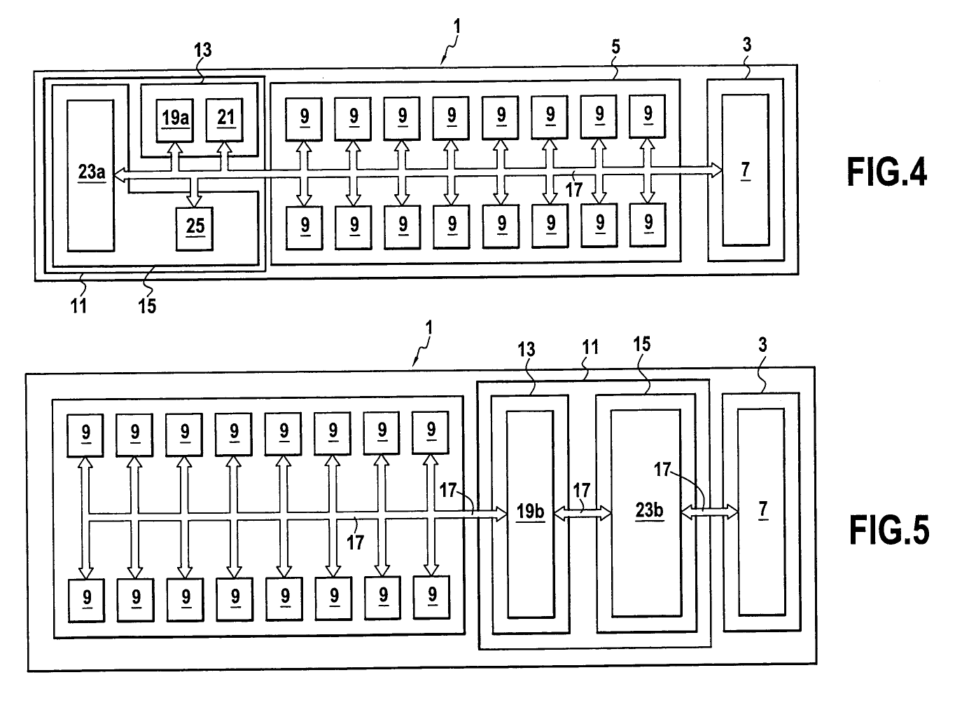

FIGS. 4 and 5 show embodiments of the gateway 1 as a programmable component of the field-programmable gate array (FPGA) type or as an application-specific integrated circuit (ASIC) type component.

FIG. 4 shows a simple and inexpensive embodiment of the gateway 1 in an FPGA component in a full IP programmable architecture.

In this embodiment the first entity 3 comprises a packet-switched interconnection element 7 of the Serial RapidIO™ type. The second entity 5 has a set of ports 9 comprising SPI ports.

The conversion means 11 comprise storage means 13 and control means 15 connecting the first entity 3 to the second entity 5 via an interconnection bus 17 enabling dialog to take place between the various portions of the communications gateway 1.

In this example, the storage means 13 comprise a first buffer memory 19a having two accesses (e.g. a random access memory (RAM) and a direct access memory 21 (DMA)). The control means 15 comprise a control unit 23a (e.g. a 32-bit controller) connected to a code memory 25 storing the program code and the routing parameters of the control unit 23a, or more generally of the gateway 1. It should be observed that the routing parameters of the code memory 25 may optionally be initialized when the gateway is started.

Coding or describing the behavior and the architecture of the communications gateway 1 can be performed using a hardware description language of the VHDL type (very high speed, or VHSCI, hardware description language) or by using a tool for automatically generating a configurable system. This coding can easily be modified to adapt to any change relating to the various elements of the gateway 1. For example, it is possible to change the number of ports 9 merely by modifying the programming of the gateway 1. Thus, the gateway 1 in this example is very flexible in use and constitutes an embodiment that is simple and inexpensive.

For the data packets received from the first entity 3, the storage means 13, and more generally the buffer memory 19a, recover and store temporarily these data packets. Thereafter, the control unit 23a decodes these data packets to recover the elementary data portions dedicated to each of the ports 9 and to allocate each elementary data portion to the corresponding port 9.

In contrast, for the data packets being sent to the first entity 3, the storage means 13 recover and store temporarily in the buffer memory 19a the elementary data coming from the various ports 9. Thereafter, the control unit 23a transforms this elementary data into data packets prior to sending it to the first entity 3.

FIG. 5 shows a second embodiment of the gateway 1 using an ASIC component, which is more compact and which lends itself better to mass production.

Also in this example, the first entity 3 includes a packet-switched interconnection element 7 of the Serial RapidIO™ type and the second entity comprises a set of ports 9 including SPI ports.

Similarly, the conversion means 11 comprising the storage means 13 and control means 15 connect the first entity 3 to the second entity 5 via interconnection buses 17 enabling dialog to take place between the various portions of the gateway 1.

In this example, the storage means 13 also comprise dual access buffer memories 19b and the control means 15 comprise a control unit 23b (e.g. a sequencer) interposed between the storage means 13 and the first entity 3. Furthermore, the storage means 13 are interposed between the set of ports 9 and the control means 15.

Thus, for data packets received from the first entity 3, the control means 15 recover said data packets and break them down depending on their destination ports before storing them temporarily in the storage means 13. Thereafter, each port 9 recovers the elementary data addressed thereto.

In contrast, for data packets sent to the first entity 3, each port 9 stores its elementary data in the buffer memories 19b. Thereafter, the control means 15 recover the elementary data from the buffer memories 19b in order to generate a frame or data packets addressed to the first entity 3.

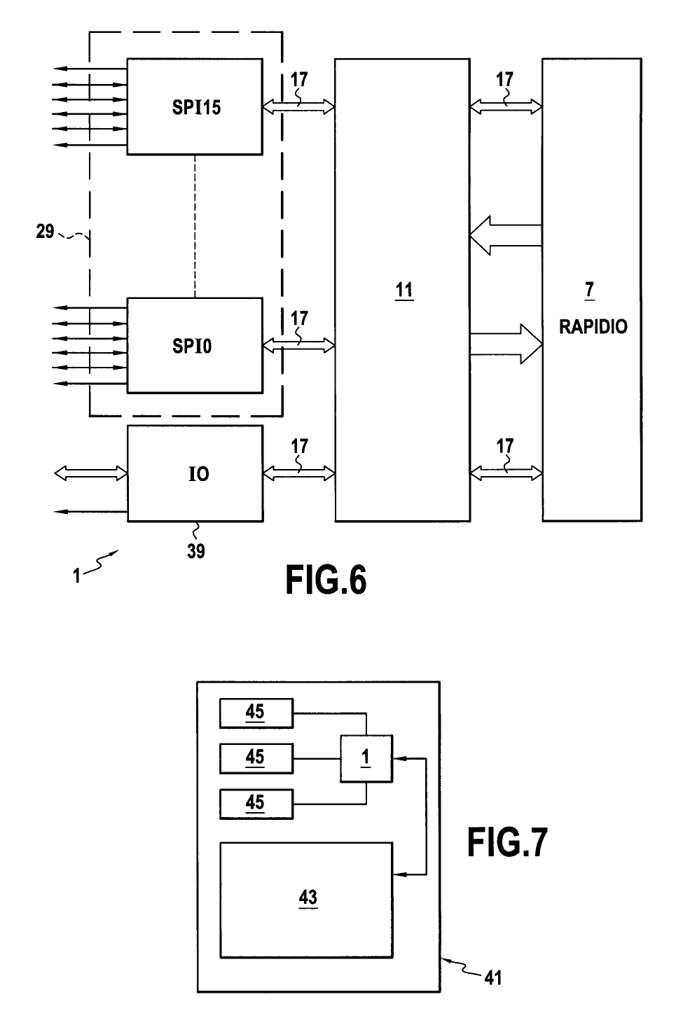

FIG. 6 shows an example of an embodiment of a communications gateway 1 including a RapidIO™ block 7, a conversion block (conversion means 11 in the preceding figures), and an SPI block 29 having sixteen SPI ports SPI0 to SPI15, together with an inlet/outlet block 39 (IP) of the GPIO type. The conversion block 11 exchanges data, transmission signals, and control signals via interconnection buses 17 between firstly the RapidIO™ block 7 and secondly the SPI and IO blocks 29 and 39.

The RapidIO™ block 7 comprises a logic layer, a transport layer, and a physical layer.

The logic layer includes the following functions: reading and writing, maintenance transactions, messages, “doorbells”, logical recognition, and direct memory access (DMA).

The transport layer includes the following functions: distributing data packets having a source and a destination, up to 64,000 peer-to-peer ID devices eliminating the need to pass via a common host, and providing the option of multicasting.

Amongst other things, the physical layer comprises: a clock; a synchronizer device; peer-to-peer topology; and other standard characteristics of RapidIO™.

The SPI block 29 serves to provide an interface with external components in master or slave mode. The main function of an SPI port may be serialize/deserialize data and generate selection signals.

The general GPIO interface block 39 serves to generate specific input/output functions, e.g. defining the input or the output of each IO pin and the default values for the outputs, whenever the RapidIO™ interface is not activated after a certain length of time elapsed (time out), it also generates the software or hardware initialization outputs “RESET” needed by each SPI port, and it performs the “watchdog” function associated with each SPI port to monitor proper operation of subscribers connected to each of the ports 29. In a status word that is accessible to the RapidIO™ block 7, it centralizes the states of the ports 29 together with the presence of subscribers, it controls buffer memory overflow in transmission and in reception, and it detects single event upset (SEU) errors. It also generates an electrical synchronization signal that is activated by a dedicated multicast frame. This signal may be used by the subscribers and it enables jitter in the high bitrate serial link to be measured in order to verify the quality of interconnections.

The conversion block 11 serves to recover information deserialized by the SPI ports and enables a data buffer zone to be created that feeds the RapidIO™ block 7. Simultaneously, it enables information deserialized by the RapidIO™ block 7 to be recovered and it serves to decode and make available the elementary data dedicated to each SPI port 29. Thus, the conversion block 11 guarantees data integrity and ensures independence between the speed of the SPI block 29 and the speed of the RapidIO™ block 7.

Thus, the gateway 1 enables formatted information to be exchanged between a high bitrate RapidIO™ bus and sixteen SPI ports with simultaneous processing of the sixteen ports.

More particularly, the gateway 1 enables the state and the presence of subscribers to the SPI ports to be verified. It also enables logic input/output signals of the time out reversal (TOR) type to be managed, a RESET initialization signal to be generated that is dedicated to each port, logic signals to be acquired or played back, and TOR outputs to be put into a default logic state after a predetermined time out has elapsed. The gateway 1 thus enables an electrical output signal to be generated on decoding a multicast event type short frame to be decoded, enables SEU protection to be performed on registers and internal memories with copying into a state register, enables a detected SEU to be copied into a state register, and issues a doorbell type short frame in the event of an anomaly.

The communications gateway 1 can be used in an airplane computer architecture. FIG. 7 is a diagram showing an example of an airplane computer 41 having at least one central unit 43, acquisition means 45, and at least one gateway (as shown in the previous figures) providing an interface between the central unit 43 and the acquisition means 45.

What is claimed is:

1. A communications gateway comprising:
a first entity including at least one packet-switching interconnection element communicating by data packets;
a second entity including a set of ports communicating by means of an elementary data set comprising data that is discrete, in serial form, or in parallel form; and
conversion means connecting said first entity with said second entity to convert between said data packets and said elementary data set so as to enable communication between said first and second entities, said conversion means comprising:
storage means for temporarily storing said data packets coming from said first entity; and
control means for decoding said temporarily-stored data packets to recover elementary data portions dedicated to ports from amongst said set of ports before sending each of said elementary data portions to its destination port.

2. A gateway according to claim 1, wherein said storage means are designed to store temporarily said elementary data set coming from said second entity, and wherein said control means are designed to transform said temporarily-stored elementary data set into data packets feeding said first entity.

3. A gateway according to claim 1, wherein said control means are designed to handle information decoded by the first entity from a specific data packet in order to generate a synchronization pulse.

4. A gateway according to claim 1, the gateway being made in a programmable component.

5. A gateway according to claim 1, the gateway being made in an application specific integrated circuit.

6. A gateway according to claim 1, wherein said set of ports comprises discrete inputs/outputs such that said elementary data set comprises discrete data.

7. A gateway according to claim 1, wherein said set of ports includes at least one serial port such that said elementary data set includes data in serial form.

8. A gateway according to claim 1, wherein said at least one serial port is of the SPI synchronized serial port type.

9. A gateway according to claim 1, wherein said packet-switching interconnection element is of the Serial RapidIO™ type.

10. An airplane computer comprising at least one central unit and acquisition means and including at least one gateway according to claim 1, wherein said gateway is an interface between said at least one central unit and said acquisition means.
